(19) United States
(12) Patent Application Publication
(10) Pub. No.: US 2002/0082842 A1
(43) Pub. Date: Jun. 27, 2002

(54) Voice-controlled tractor-mounted loader

(75) Inventor: Jean Viaud, Gray (FR)

Correspondence Address: Jimmie R. Oaks, Patent Department, DEERE & COMPANY, One John Deere Place, Moline, IL, 61265-8098, US

(73) Assignee: Deere & Company, a Delaware Corporation

(21) Appl. No.: 10/005,573

(22) Filed: Nov. 6, 2001

(30) Foreign Application Priority Data
Dec. 21, 2000 (DE) 100 63 901.1

(51) Int. Cl. G10L 21/00

(52) U.S. Cl. 704/275

(57) ABSTRACT

A tractor is equipped with a front end loader including a boom mounted for being raised and lowered through the operation of a pair of hydraulic boom motors having a bucket attached to the arms thereof for being rocked about an axis of connection by a hydraulic bucket motor. A control system includes manual controls for controlling operation of the boom and bucket motors. The control system also includes a speech recognition device that is programmed for recognizing the speech of authorized operators and for sending signals responsive to certain command words for effecting desired control of the boom and bucket motors.

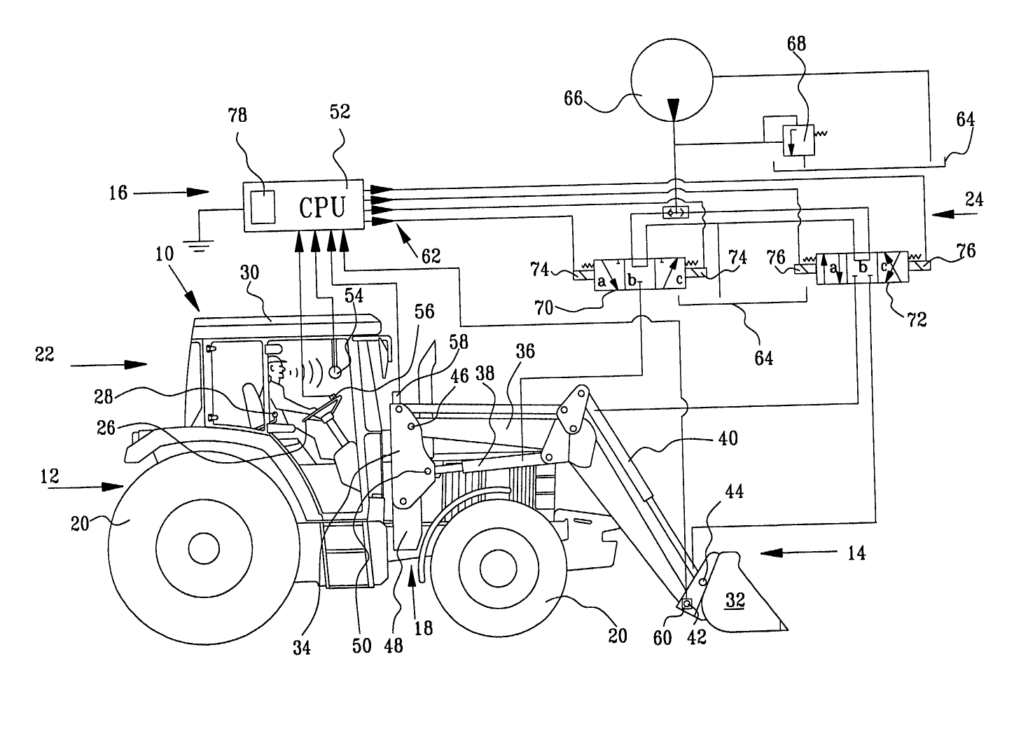

### FIELD OF THE INVENTION

The invention pertains to an operating system for a tractor-mounted loader.

### BACKGROUND OF THE INVENTION

Various types of loading devices are known, e.g., in the form of farming tractors logging tractors or industrial tractors with a front loader or rear loader that is constructed in the form of a wheel loader or the like. The operation of these loading devices is quite complex because the base vehicle needs to be driven and steered while the loader frequently needs to be operated simultaneously.

It is also known (ASAE Paper 993186) to utilize speech recognition systems in agricultural machines in order to store information on the processed field in memory during the operation of the machine and to subsequently use this information during the additional processing of the field.

The problem to be solved with the invention can be seen in the fact that this technology can only be utilized in a very limited field of application.

### SUMMARY OF THE INVENTION

According to the present invention there is provided an improved control system for a tractor-mounted loader.

An object of the invention is to provide a control system for a tractor-mounted loader which employs voice recognition technology, whereby an operator may control the loader, at least in part, by speaking.

A more specific object of the invention is to provide a loader control system, according to the preceding object, wherein the voice recognition system is responsive to short, terse and clear comments, e.g., “stop”, “go”, etc.

Yet a more specific object of the invention is to provide a loader control system embodying voice recognition technology that operates for causing the loader to raise a load to a certain height, in response to an exemplary voice command, such as “truck” and to dump the lifted load in response to another voice command, such as “dump”.

Another object of the invention is to provide a speech-controlled loader wherein certain operators can be excluded from operating the loader in accordance with the function-sensitive vocabulary that is loaded into the main memory of the computer used in the system.

These and other objects of the invention will become apparent from a reading of the ensuing description together with the appended drawings.

### BRIEF DESCRIPTION OF THE DRAWINGS

The sole figure is a schematic right side view of an agricultural tractor carrying a front-mounted loader, and embodying a voice-controlled, electro-hydraulic control system in accordance with the principles of the present invention.

### DESCRIPTION OF THE PREFERRED EMBODIMENT

The figure shows a loading device 10 with a carrier vehicle 12 and a loader 14, with the loading device 10 being operated by an operating system 16 according to the invention.

The carrier vehicle 12 is here disclosed in the form of an agricultural tractor, with the loader 14 being shown as a front-mounted loader. Other arrangements could be used as well, for example, a rear-mounted loader, an industrial wheel loader, a telescopic loader, etc.

The carrier vehicle 12 includes an undercarriage 18 supported on front and rear pairs of drive wheels 20, with the forward pair of wheels 20 being steerable. An operator's station or platform 22 is positioned over a rear section of the undercarriage 18. The undercarriage is equipped with various components, e.g., a transmission, an engine, hitches and the like, as it is known, for example from conventional agricultural tractors, and are not further described. The carrier vehicle is also equipped with an adjusting device 24. The operator's station 22 includes, among other things, a steering wheel 26, an actuating device 28 and a cab 30, in which there is space for at least one operator. The steering wheel 26 is conventional and may be equipped with a not-shown central instrument unit.

The aforementioned actuating device 28 merely represents one of a series of actuating devices for the transmission, the engine and the like, with said actuating device serving to control the loader 14. This actuating device 28 is conventionally realized mechanically in the form of a lever and acts upon the adjusting device 24 via a rod assembly, a cable pull or electrically. The actuating device 28 has, in principle, priority over the operating system 16.

It is not imperative that there be a cab 30, there could instead be just a roof that is arranged on a frame, a canopy top, a covered bracket or simply a post on which components can be mounted.

In the embodiment shown, the loader 14 is constructed in the form of a front loader as it is known from the agricultural industry and communal organizations. Among other things, the loader 14 contains posts 34, a loader boom or arm structure 36, a work tool 32, servomotors 38 for the loader boom 36, and at least one servomotor for the work tool 32.

The loader 14 is disclosed in this embodiment serves, for example, for loading bulk material that lies on the ground into a container such as that of a trailer or hauling truck, for example. In this case, the loading device 10 pushes the work tool 32, here disclosed as a bucket, into the heap of bulk material, tilts the tool 32 backwards, raises the loader boom 36, moves the carrier vehicle 12 back towards the trailer or truck container, stops the carrier vehicle and then tilts the tool 32 forward to dump its load. After this the process begins anew.

In another exemplary application, where the carrier is in the form of a fork lift truck, a palette situated on the ground is raised by a palette fork and placed onto a transport vehicle.

The tool 32 is connected in a pivoted fashion to the front end region of the loader boom 36 in a lower bearing 42 and to the servomotor 40 in an articulated fashion in an upper bearing 44. Its position is controlled by the operating system 16 or the actuating device 28.

The posts 34 accommodate the respective rear end regions of the loader boom 36 in a vertically pivoted fashion in a bearing 46 and are connected in a stable fashion to the undercarriage 18 by consoles 48. The posts 34 contain a second bearing 50 for the rear end of the servomotor 38.

The loader boom 36 is composed of two arms that are rigidly connected to one another and are angled between their ends to form an angle between approximately 130° and 150°. The entire boom 36 can be vertically pivoted about the bearing 46 by means of the servomotors 38. Each servomotor 38 is constructed in the form of a single-acting hydraulic motor; however, this is not absolutely imperative. Alternatively, it would also be conceivable to utilize a double-acting hydraulic motor or even an electric motor. The servomotor 38 is supported in a pivoted fashion with its rear end region in the bearing 50 and with its front end region in a not-shown bearing arranged in the region in which the two arms of the boom 36 are connected to one another. The boom 36 is raised by means of the servomotors 38, with the boom 36 being lowered due to gravitational force. The servomotors 38 are supplied with power by the adjusting device 24.

The servomotor 40 is also constructed in the form of a hydraulic motor, however, it is a double-acting hydraulic motor that operates for adjusting the tool 32 in both directions about the pivotal connections 42. The utilization of an electric motor would also be conceivable in this case. The servomotor 40 engages into the bearing 44 with its front end region, and its rear end region is held in a pivoted fashion in the region in which the two arms of the boom 36 are connected to one another. However, the latter aspect is not shown in the figure. The servomotor 40 serves for adjusting the tool 32 and is supplied with power from the adjusting device 24.

The operating system 16 contains a speech recognition device 52, a microphone 54, an activating device 56, a sensor 58 that is assigned to the boom 36, a sensor 60 that is assigned to the tool 32 and an interface 62 with the adjusting device 24.

The speech recognition device 52 is contained in an on-board computer that is usually arranged on the driver's platform 22. For training and calibration purposes, the on-board computer can also be detached and, for example, connected to another computer. The speech recognition device 52 contains an automatic speech recognition program as it is known from the state of the art and, for example, explicitly described in the initially cited document that forms part of the state of the art. Such a speech recognition program contains a memory 78 with words, sentences, or parts of sentences that can be assigned to the word, sentence or part of a sentence which is spoken by the operator and recorded by the microphone 54. A signal is assigned to each word, sentence or part of a sentence in the memory 78. These signals are routed to the adjusting device 24 via the interface 62 and cause a certain movement of the adjusting device. The memory 78 may be realized, in particular, loaded, in such a way that it also recognizes the operator and only performs the respective function once it has determined that the operator is an authorized operator. The memory 78 may also contain and assign terms in several languages such that operators who speak different languages are able to operate the loader. In order to ensure that such a program is able to reliably recognize and assign the terms, it is necessary to regularly perform speech training that can be carried out separately of the loading device 10 while the on-board computer is detached. The speech recognition device 52 may also be equipped with various memories 78 for different attachments such that, for example, an attached sowing or spraying device can also be controlled. The speed of the adjustment can also be controlled by correspondingly defined terms. The speech recognition device 52 is operated with an external or internal voltage source as indicated in the figure.

The microphone 54 is situated in the immediate vicinity of the operator and mounted on the cab 30 in this embodiment. Alternatively, the microphone 54 could also consist of a microphone with or without a cable which is carried by the operator or integrated into the steering wheel 26 or a windshield. In this respect, the only important aspects are that a reliable recording of the speech takes place and that the spoken terms are forwarded to the speech recognition device 52 by means of the shown connection that is not illustrated in greater detail, for example, a wire or in a wireless fashion.

The activating device 56 is situated in the immediate vicinity of the operator and symbolically illustrated on the steering wheel 26. However, this is not absolutely imperative. Alternatively, the activating device 56 could also be situated on the actuating device 28. In any case, it is connected to the speech recognition device 52 by means of a wire or in a wireless fashion and has the function of permitting or blocking the speech recognition by means of the microphone and the speech recognition device 52. This is intended to prevent a spoken term from causing an undesired adjusting signal. The activating device 56 may be designed in such a way that it basically blocks speech recognition and only allows such speech recognition if it is intentionally actuated. The activating device 56 could also be provided with or connected to a safety device that, for example, blocks the speech recognition if a high driving speed is reached, if the operator is under the influence of alcohol, etc.

The sensor 58 determines the position between the boom and at least one post 34 within the region of the bearing 46, and the distance between the ground and the tool 32 is derived from said position. This sensor 58 could also measure the position of the servomotor 38 relative to the post 34. A sensor 58 of this type which, for example, is constructed in the form of a rotary potentiometer makes it possible to stop the movement of the boom 36 once it has reached a certain position that is predetermined by a speech-derived signal. The sensor 58 is also connected to the speech recognition device 52 by means of a wire or in a wireless fashion and is fed corresponding signals to the speech recognition device.

The sensor 60 is arranged in the region of the bearing 42 and consequently determines the position of the tool 32 relative to the boom 36. The sensor 60 may simply determine the end positions such that the loading or unloading of the tool 32 can be easily controlled and monitored.

The interface 62 serves for connecting the operating system 16 to the adjusting device 24. The utilization of such an interface 62 makes it possible to realize and operate the adjusting device 24 independently of the operating system 16. The interface 62 also makes it possible to control valves that are used for the adjustment of the servomotors 38 and 40 and are described in greater detail below.

The adjusting device 24 is constructed in the form of a hydraulic system and contains a reservoir 64, a pump 66, a pressure control valve 68, a valve 70 for the boom 36 and a valve 72 for the tool 32.

The reservoir 64, the pump 66 and the pressure control valve 68 are conventionally constructed in the form of an open system and connected to one another. Consequently, these components do not require a more detailed description.

The valve 70 is constructed in the form of a three-position, three-way valve and set into a locked position a, a supply position b, or a discharge position c by means of two solenoids 74. In the locked position a, the servomotor 38 is blocked and the pump 66 conveys a pressure medium into the reservoir 64. In the supply position b, a pressure medium is supplied to the servomotor 38 such that it extends and lifts the boom 36. In the discharge position c, the pressure medium is able to flow back into the reservoir 64 such that the boom 36 is lowered by the effect of gravity. The solenoids 74 are connected to the voice recognition device 52 via the interface 62 by means of a wire or in a wireless fashion.

The valve 72 serves for controlling the servomotor 40 that adjusts the position of the tool 32 and is constructed in the form of a three-position, four-way valve that can also be set into a locked position a, a retracted position b and an extended position c by means of solenoids 76. The solenoids 76 are connected to the speech recognition device 52 via the interface 62 by means of a wire or in a wireless fashion. In the locked position a, the servomotor 40 is blocked and the pressure medium conveyed by the pump 66 flows back into the reservoir 64. IN the retracted position b, the pressure medium is supplied to the end of the servomotor 40 on the side of the piston rod. In the extended position c, the pressure medium is supplied to the end of the servomotor 40 on the side of the piston. Four connections lead from the interface 62 to the hydraulic system 24. The hydraulic system 24 may also be modified such that it includes two servomotors 38 and/or 40. This would correspondingly increase or decrease the number of connections at the interface 62.

It is quite obvious that the posts 34, the servomotors 38, the consoles 48 and the respective bearings 42, 44, 46 and 50 are provided twice, namely, on each side of the undercarriage 18.

According to the previous description, the new operating system 16 functions as described below.

As long as the activating device 56 is not actuated, the movement of the boom 36 and the tool 32 is controlled by the actuating device 28, i.e., without the participation of the operating system 16.

If the control should be effected by means of the operating system 16 according to the invention, the operating system needs to be connected to the adjusting device 24 via the interface 62. Subsequently, the activating device 56 is actuated and a command is transmitted to the speech recognition device 52 by means of the microphone 54. This command consists, for example, the word “lift”. The speech recognition device 52 recognizes the command “lift” and assigns this command to a signal. This signal causes a current to be applied to the solenoid 74 of the valve 70 which moves said valve into the supply position b. This causes the servomotors 38 to be extended and the boom 36 to be raised. This lifting movement is interrupted by the sensor 58 which recognizes that the boom 36 has reached a certain height or the maximum height, or the operator issues a command, e.g., “stop”. This command causes the electrical current to the solenoid 74 in question to be cut off and the valve 70 to be pressed back into the locked position a by means of centering springs. The tool 32 can be actuated or the boom 36 can be lowered by means of additional, pre-programmed commands.

Having described the preferred embodiment, it will become apparent that various modifications can be made without departing from the scope of the invention as defined in the accompanying claims.

1. In a combination of a tractor and a loader mounted on the tractor and including at least one load bearing member mounted for being raised and lowered by operation of at least one powered device coupled to the load bearing member, the improvement comprising: an adjusting device coupled to said powered device and being operable for either lifting or lowering said load bearing member in response to receiving appropriate control signals; and a speech recognition device coupled to said adjusting device for transmitting said appropriate control signals thereto in response to receiving appropriate voice commands from an operator.

2. The combination, as defined in claim, and further including a position sensing device mounted for sensing the position of said load bearing member and producing a position signal representative of said position; said sensing device being coupled to said adjusting device for halting movement of said load bearing member at a pre-selected position corresponding to said position signal.

3. The combination, as defined in claim 1, wherein said speech recognition device includes a memory in which is stored information by which different operators are identified, with said speech recognition device sending out control signals only in response to voice commands of a recognized operator.

4. The combination, as defined in claim 1, and further including a an activating device coupled to said speech recognition device for selectively activating the latter.

5. The combination, as defined in claim 4, wherein said adjusting device includes a manually-operable device for effecting operation of said powered device exclusive of said speech recognition device.
